(19) United States
(12) Patent Application Publication
(10) Pub. No.: US 2014/0140207 A1
(43) Pub. Date: May 22, 2014

(54) SYSTEM AND METHOD FOR REDUCING LOADS OF MOBILITY MANAGEMENT ENTITY (MME) IN CORE NETWORKS

(71) Applicant: NATIONAL CHIAO TUNG UNVERSITY, Hsinchu City (TW)

(72) Inventors: JYH-CHENG CHEN, HSINCHU CITY (TW); MING-HONG TSAI, TAINAN CITY (TW); YI-BING LIN, HSINCHU COUNTY (TW); YINGRONG CORAL SUNG, TAIPEI CITY (TW)

(73) Assignee: NATIONAL CHIAO TUNG UNIVERSITY, Hsinchu City (TW)

(21) Appl. No.: 13/867,268

(22) Filed: Apr. 22, 2013

(30) Foreign Application Priority Data
Nov. 20, 2012 (TW) 101143198

(51) Int. Cl. H04W 28/02

(52) U.S. Cl. CPC H04W 28/0215
USPC 370/230

(57) ABSTRACT

The present invention provides a system and method for reducing loads of a mobility management entity in core networks. An object sending a connection-request message asking for network access to a base station through a wireless network; the base station receiving the connection-request message and sending it to core networks through a network; a mobility management entity (MME) in the core network receive the connection-request message. If the core network is busy and refuses to interconnect with the object, MME calculating according to a management rule a back-off time; MME transmitting a response message including the back-off time to the object through the base station, and the object sending out a connection-request message again after the back-off time has elapsed according to the response message.

### BACKGROUND OF THE INVENTION

1. Field of the Invention

The present invention relates to a technology for reducing loads of networks, particularly to a system and method for reducing loads of a Mobility Management Entity (MME) in core networks.

2. Description of the Related Art

Machine-to-Machine (M2M) communication generally refers to information exchange between machines. Using a machine to control or operate another far-end machine is a novel technological conception. An M2M system includes hardware and software, whereby far-end hardware device can exchange information via a network. The state of the art is using an MME to administrate all interconnect information in an LTE (Long Term Evolution) wireless network. As the LTE technology can effectively control devices, it is expected to be used widely in the fields of automated transmission, far-end control, measuring original data of far-end wired devices, and wireless communications.

It is expected that the application of the M2M technology will be further more popularized. In addition to mobile phones, various household appliances, such as refrigerators and air conditioners, may become MTC (Machine-Type Communication) devices in the LTE wireless network in the future. Persistent connection-requests by multitudinous MTC devices to the core network would overload the core network. The core network allocates different network access allowable time intervals, i.e. the Grant Time Intervals (GTI), to different types or functions of MTC devices. Numerous MTC devices ask for network access at the same time in the initial stage of GTI. Then, the load of the core network may vary dramatically and needs to be distributed. However, the current technology cannot reduce the MME loads caused by M2M service in the LTE wireless network. Thus, all the MTC devices can only repeat their connection-requests, which have been rejected before.

Accordingly, the present invention proposes a system and method for reducing MME loads in core networks to overcome the above-mentioned problems.

### SUMMARY OF THE INVENTION

The primary objective of the present invention is to provide a system and method for reducing loads of an MME in core networks, wherein the connection-requests of objects are distributed to different time points, whereby the count of connection-requests during each unit time is reduced, and whereby the problem of core network overload is solved.

Another objective of the present invention is to provide a method for reducing loads of an MME in core networks, wherein the back-off time is reset to be 1 time slot once the back-off time is progressively increased from 1 time slot to over a threshold time interval.

To achieve the abovementioned objectives, the present invention proposes a system for reducing loads of an MME in core networks, which comprises at least one object, at least one base station, and an MME. The object sends out a connection-request message asking for network access through a wireless network. The base station receives the connection-request message and sends out the connection-request message through a network. The MME in core networks receives the connection-request message. If the core network is busy and rejects the connection-request of the object, the MME calculates according to a management rule a time point at which the object is allowed to send out a connection-request message again, and transmits a response message containing the time point to the object through the base station.

The present invention also proposes a method for reducing loads of a mobility management entity in core networks, which comprises steps: at least one object sending a connection-request message asking for network access to a base station through a wireless network; the base station receiving the connection-request message and sending the connection-request message to core networks through a network; an MME in the core network receiving the connection-request message; if the core network is busy and rejects the connection-request of the object, the MME calculating according to a management rule a time point at which the object is allowed to send out a connection-request message again; and the MME transmitting a response message containing the time point to the object through the base station; and the object sending a connection-request message again at the time point carried by the response message.

Below, embodiments are described in detail to make easily understood the objectives, technical contents, characteristics and accomplishments of the present invention.

### BRIEF DESCRIPTION OF THE DRAWINGS

FIG. 1 is a diagram schematically showing the architecture of a system for reducing loads of an MME in core networks according to one embodiment of the present invention;

FIG. 2 is a flowchart of a method for reducing loads of an MME in core networks according to one embodiment of the present invention; and

FIGS. 3A-3D are diagrams schematically showing that MME calculates time points of sending out connection-request messages respectively according to different embodiments of the present invention.

### DETAILED DESCRIPTION OF THE INVENTION

The present invention discloses a system and method for reducing loads of an MME in core networks, which is used to solve the problem of core network overload in the M2M (Machine-to-Machine) service of an LTE (Long Term Evolution) network, and which enables network service providers to select different methods to distribute load according to the types of MTC (Machine-Type Communication) devices or the status of business operation.

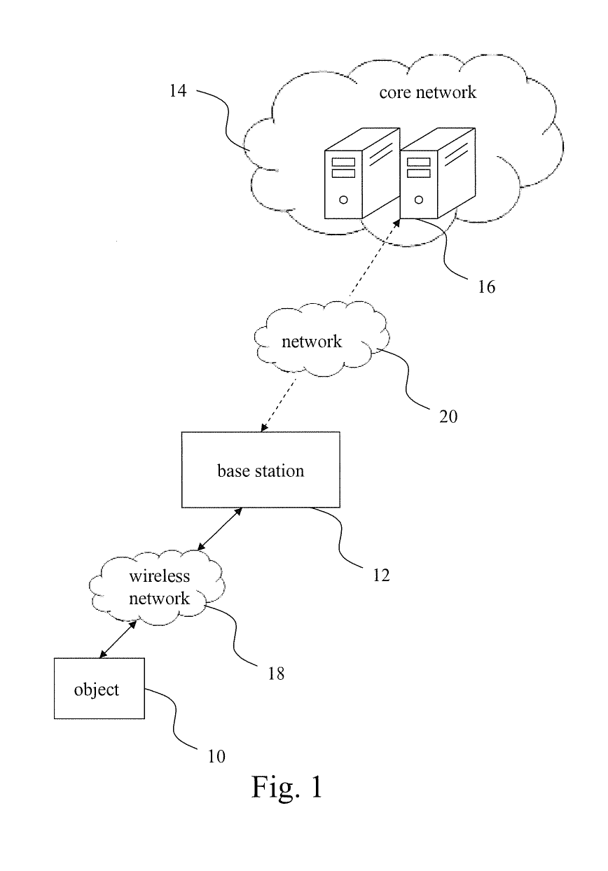

Refer to FIG. 1 a diagram schematically showing a system for reducing loads of a mobility management entity (MME) in core networks according to one embodiment of the present invention. The system of the present invention comprises at least one object 10, at least one base station 12, and core networks 14. The core network 14 includes a plurality of servers functioning as MME (Mobility Management Entity) 16. The object 10 is an MTC device. The object 10 sends out a connection-request message asking for network access through a wireless network 18. The base station 12 is an LTE eNodeB base station. The base station 12 receives the connection-request message and sends out the connection-request message through a wired or wireless network 20. The MME 16 administrates the signals sent to the core network 14. If the core network 14 is busy and rejects the connection-request of the object 10, the MME 16 calculates according to a management rule a time point at which the object 10 is allowed to send out a connection-request message again, and transmits a response message containing the time point to the object 10 through the base station 12.

The connection-request message includes the size of a time slot (e.g. 1 second, 2 seconds, or 5 seconds) and the count of the connection-requests the object 10 has made. According to a management rule and with the unit being the time slot, the MME 16 works out a back-off time, which is measured by the time slot and is not less than 1 time slot. After the back-off time has elapsed, the object 10 is allowed to send out a connection-request message again.

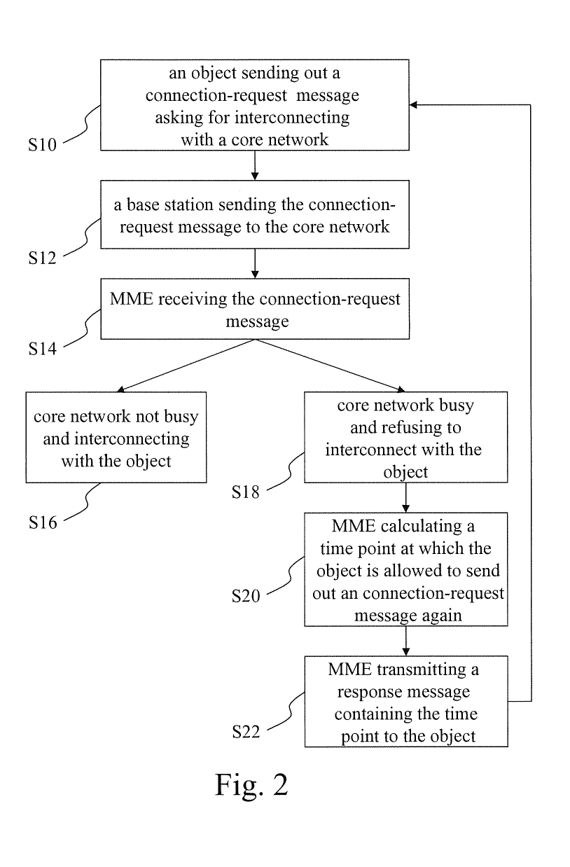

Refer to FIG. 2 a flowchart of a method for reducing loads of an MME in core networks according to one embodiment of the present invention. The method of the present invention is applied to the system shown in FIG. 1. In Step S10, at least one object sends a connection-request message asking for network access to a base station through a wireless network. In Step S12, the base station receives the connection-request message and sends the connection-request message to core networks through a wired or wireless network. In Step S14, MME in the core network receives the connection-request message. If the core network is not busy, the core network interconnects with the object in Step S16. If the core network is busy, the core network refuses to interconnect with the object in Step S18, and MME in the core network calculates according to a management rule a time point at which the object is allowed to send out a connection-request message again in Step S20. In Step S22, MME transmits a response message containing the time point to the object through the base station. Then, the process returns to Step S10, and object sends out a connection-request message again.

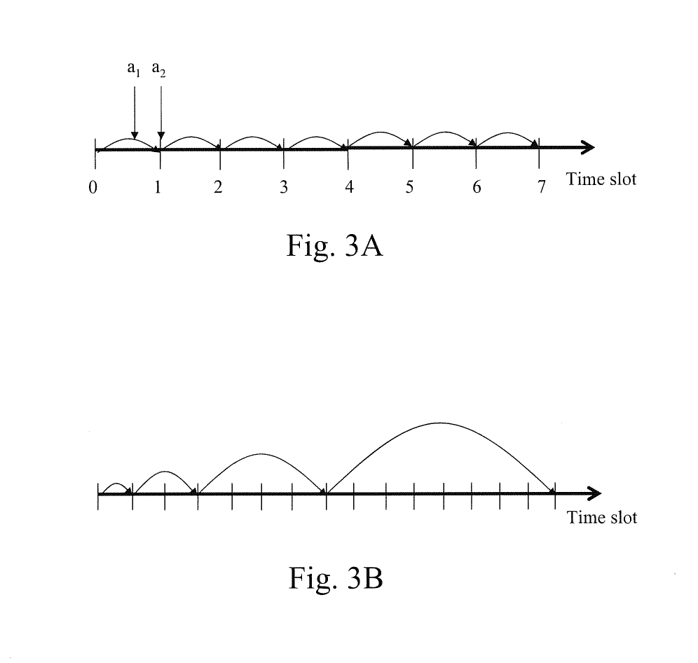

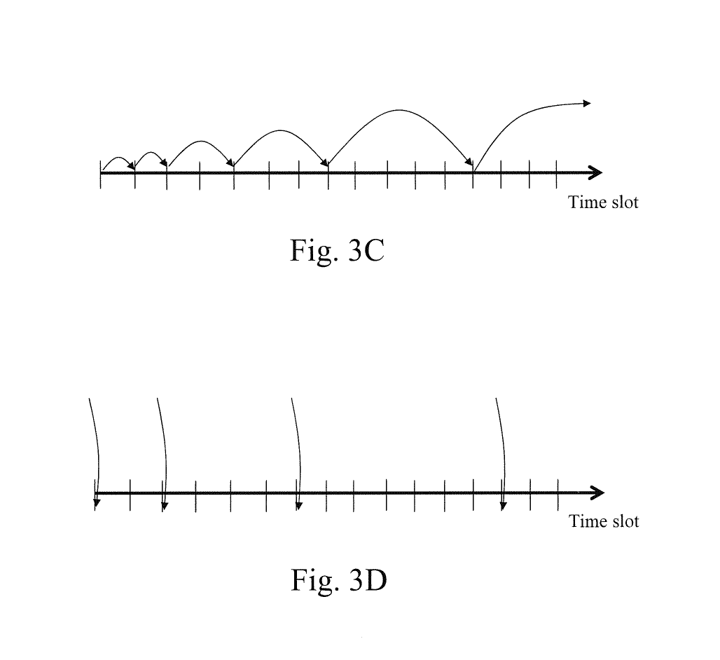

The present invention includes several management rules to determine the time points at which the object is allowed to send a connection-request message. Refer to FIG. 3A a diagram schematically showing a management rule according to one embodiment of the present invention. Suppose that MME rejects the connection-request of the object and that the time point a₁ at which the object sends out the connection-request message is not exactly at an integral time point of the time slot axis. Suppose that 1 time slot is 1 second and that the time point a₁ is between the 0^{th} second and the 1^{st} second. Thus, MME will respond to the object that the object should send out a connection-request message again at the next integral time point of the time slot axis, which is nearest to the time point a₁ (i.e. the 1^{st} second). Suppose that MME rejects the connection-request of the object and that the time point a₂ at which the object sends out the connection-request message is exactly at an integral time point of the time slot axis, e.g. a₂ is exactly at the 1^{st} second. Thus, MME will respond to the object that the object should send out a connection-request message again at the next integral time point of the tune slot axis, i.e. the 2^{nd} second. Such a management rule has lower load reduction effect. However, the connection-request message needn't contain the message of time slots and the count of connection-requests the object has made.

FIGS. 3B-3D are diagrams schematically showing other three management rules respectively according to three embodiments of the present invention. In the three embodiments, the problem is solved with a concept of back-off windows, which will be demonstrated with an example below. If MME is overloaded and rejects a first connection-request of an object at a first time point, it allows the object to make a second connection-request at a second time point after the object has waits for an interval of time. The abovementioned interval of time is also called the back-off time in the present invention. It's length is called the back-off length, which means how many time slots the object waited, and the abovementioned back-off length will be called the first back-off length in the current example. Therefore, the second connection-request is sent out at the second time point, which is equal to the first time point plus the first back-off time. If the second connection-request of the object is rejected again, the second back-off time will be double the first back-off time, i.e. the object is allowed to sent a third connection-request at a third time point, which is equal to the second time point plus the double of the first back-off time. In the abovementioned example, the object has to store additional information, i.e. the back-off length, into the connection-request message. If the magnitude of the back-off time is 8, it means that the object has waited for a time interval of 8 time slots.

Refer to FIG. 3B. In this embodiment, the back-off time is increased exponentially after each rejection of the connection-request. The back-off time is 1 time slot after the first rejection; the back-off time is 2 time slots after the second rejection; the back-off time is 4 time slots after the third rejection, and the others can be deduced similarly. Suppose that the connection-request is rejected at a time point, which is not at the integral time point of the time slot axis, and suppose that the current back-off length is 16. 16 multiplied by 2=32. Next, calculate the difference dₜ between the nearest integral time point and the current time point. dₜ would be smaller than 1 time slot but will be regarded as 1 time slot. Then, calculate the next time point at which the object is allowed to send out a connection-request message again. The next time point is equal to [31×the time slot+dₜ+the current time point] and expressed by Equation (1):

TPₙₑₓₜ=dₜ+(BOLₙₑₓₜ−1)×BOT+TP_{now} (1)

wherein TP_{now} is the time point at which the connection-request message is sent out this time, TPnext the time point at which the connection-request message will be sent out next time, BOT the length of 1 time slot, and BOLnext the back-off length after which the connection-request message will be sent out again. If the connection-request is rejected at an integral time point of the time slot axis, the next time point at which the object is allowed to send out the connection-request message again is worked out similarly except dₜ is not taken into consideration. In such a case, the next time point is calculated according to Equation (2):

TPₙₑₓₜ=BOLₙₑₓₜ×BOT+TP_{now} (2)

The object may be rejected persistently with the back-off time increased exponentially. The object having been rejected many times would have a longer the back-off time. Thus, the task thereof will be delayed significantly. In such a case, it may occur that the next time point at which the object is allowed to send out the connection-request message exceeds the time range that the classification management system assigns to the like objects. Thus, the object has to wait for the next time range that the classification management system assigns to the like objects. For example, the time range that MME assigns to objects of Group A, i.e. the time range within which the objects of Group A are allowed to make connection-requests, is from 6:00 a.m. to 8:00 a.m. The objects of Group A are no more allowed to make any connection-requests after the abovementioned time range until the next time range for Group A arrives, e.g. from 4:00 p.m. to 6:00 p.m. Thus, the exponential method of this embodiment sets a limit to the back-off length. When the back-off length exceeds the limit, the back-off length is reset to be 1 time slot lest the task of the object be delayed too much. Thereby is also reduced the probability that the next time point for making a connection-request exceeds the time range set by the classification management system.

Refer to FIG. 3C. In this embodiment, the back-off time is increased according a Fibonacci sequence after each rejection of the connection-request. The Fibonacci sequence is generated according to the equation: Fₙ₊₂=Fₙ₊₁+Fₙ, wherein n>1. Suppose that the first back-off time is 1 time slot and that the second back-off is 1 time slot too. Thus, the third back-off time is 2 time slots; the fourth back-off time is 3 time slots; the fifth back-off time is 5 time slots, and the others can be deduced similarly. In this embodiment, the object has to record the last back-off length and the current back-off length. Suppose that the connection-request is rejected by MME at a time point, which is not at an integral time point of the time slot axis. The next back-off length is equal to the last back-off length plus the current back-off length, and dₜ is also regarded as 1 time slot. In such a case, the next time point at which the object is allowed to send out a connection-request message again is also calculated according to Equation (1). If the connection-request is rejected at an integral time point of the time slot axis, the next time point is also calculated according to Equation (2). In this embodiment, the next back-off length BOLnext is worked out according to the Fibonacci sequence and then used to calculate the next time point TPnext. Similar to the exponential method demonstrated in FIG. 3B, the Fibonacci sequence method also sets a limit to the back-off length lest the object have to wait for too long a time and the task of the object be delayed too much. Thereby is also reduced the probability that the next time point for making a connection-request exceeds the time range set by the classification management system.

Refer to FIG. 3D. In this embodiment, the connection-request message is sent out at a time point randomly selected within a grant time interval (GTI). If the connection-request is still rejected, the MME will select a new time point, which is within GTI but behind the current time point. The back-off time is the interval between the current time point and the new time point. Suppose that a time slot is 1 second and that GTI is equal to 10 time slots. If the connection-request message sent out by the object is rejected at the 0^{th} second, MME will randomly select a time point between the 0^{th} second and the 10^{th} second, e.g. the 2^{nd} second shown in FIG. 3D. If the connection-request message sent at the 2^{nd} second is still rejected, the MME will randomly select a time point between the 2^{nd} second and the 10^{th} second, e.g. the 6^{th} second shown in FIG. 3D. In this embodiment, the connection-request message needn't carry the back-off length. MME can select a time point, only using GRT. Suppose that GTI is equal to 32 seconds and that the connection-request made by the object is rejected at the 10^{th} second. MME will randomly select a time point between the 11^{th} second and the 32^{nd} second and inform the object to request interconnect again at the time point.

The present invention also proposes a management rule: MME calculates the count of the rejected objects at each time point and arranges the priorities of connection-requests according to the counts of rejections the objects have experienced. The object having the highest count of rejections is arranged to interconnect with the core network at the first next time point. The object having the second highest count of rejections is arranged to interconnect with the core network at the second next time point, and so on. For example, the object having the highest count of rejections is arranged to interconnect 1 second later; the object having the second highest count of rejections is arranged t0 interconnect 2 seconds later; the object having the third highest count of rejections is arranged to interconnect 3 second later, and the others can be deduced similarly. According to the counts of rejections, MME arranges the priorities of connection-requests to distribute the loads to different points uniformly.

In conclusion, the present invention proposes a system and method for reducing loads of a mobility management entity in core networks, wherein MME selects a management rule, and wherein MME calculates according to the management rule a time point at which the object whose connection-request has been rejected is allowed to make a connection-request again, and wherein MME responds the time point to the object, whereby the object makes a connection-request at the time point again. As the MME allocates the time points for connection-requests, connection-requests are effectively distributed to different time points. Thereby, the load of core networks is reduced, and connection-requests are more likely to be accepted by the core network.

The embodiments described above are only to exemplify the present invention but not to limit the scope of the present invention. Any equivalent modification or variation according to the characteristic or spirit of the present invention is to be also included within the scope of the present invention.

What is claimed is:

1. A system for reducing loads of a mobility management entity in core networks, comprising
at least one object sending a connection-request message asking for network access through a wireless network;
at least one base station receiving said connection-request message and sending out said connection-request message through a network; and
a mobility management entity (MME) arranged in core networks, receiving said connection-request message, calculating according to a management rule a time point at which said object is allowed to send out a connection-request message again if said core network is busy and refuses to interconnect with said object, and transmitting a response message including said time point to said object through said base station.

2. The system for reducing loads of a mobility management entity in core networks according to claim 1, wherein said object is machine-type communication device.

3. The system for reducing loads of a mobility management entity in core networks according to claim 1, wherein said network is a wired network or a wireless network.

4. The system for reducing loads of a mobility management entity in core networks according to claim 1, wherein said connection-request message includes a message of a time slot and a message of a count of connection-requests that said object has made, and wherein said management rule is used to work out a back-off time, which is a time interval between two adjacent connection-requests and is measured by said time slot.

5. The system for reducing loads of a mobility management entity in core networks according to claim 4, wherein said back-off time is a time interval that said object sends out a connection-request message again, said back-off time is at least one said time slot.

6. The system for reducing loads of a mobility management entity in core networks according to claim 4, wherein said back-off time is set to be one said time slot initially, and wherein said back-off time is increased by adding two said time slots thereto each time until said back-off time exceeds a threshold time interval, whereafter said back-off time is reset to be one said time slot.

7. The system for reducing loads of a mobility management entity in core networks according to claim 4, wherein said back-off time is set to be one said time slot initially, and wherein said back-off time is increased according to a Fibonacci sequence each until said back-off time exceeds a threshold time interval, whereafter said back-off time is reset to be one said time slot.

8. The system for reducing loads of a mobility management entity in core networks according to claim 4, wherein said mobility management entity selects a time point within a preset grant time interval (GTI) randomly and asks said object to send out a connection-request message again at said time point, and wherein if said object still cannot interconnect with said core network, said mobility management entity selects a new time point behind said time point within said grant time interval, and a interval between that two time points is said back-off time of said object.

9. The system for reducing loads of a mobility management entity in core networks according to claim 4, wherein said mobility management entity determines priorities of objects according to counts of rejections of said objects, and assigns said time point to an object having a highest count of rejections.

10. A method for reducing loads of a mobility management entity in core networks, comprising steps:
at least one object sending a connection-request message asking for network access to at least one base station through a wireless network;
said base station receiving said connection-request message and sending said connection-request message to core networks through a network;
a mobility management entity in said core network receiving said connection-request message, calculating according to a management rule a time point at which said object is allowed to send out a connection-request message again if said core network is busy and refuses to interconnect with said object; and
said mobility management entity transmitting a response message including said time point to said object through said base station, and said object sending out a connection-request message again at said time point according to said response message.

11. The method for reducing loads of a mobility management entity in core networks according to claim 10, wherein said object is machine-type communication device.

12. The method for reducing loads of a mobility management entity in core networks according to claim 10, wherein said network is a wired network or a wireless network.

13. The method for reducing loads of a mobility management entity in core networks according to claim 10, wherein said connection-request message includes a message of a time slot and a message of a count of connection-requests that said object has made, and wherein said management rule is used to work out a back-off time, which is a time interval between two adjacent connection-requests and is measured by said time slot.

14. The method for reducing loads of a mobility management entity in core networks according to claim 13, wherein said back-off time is a time interval that said object sends out a connection-request message again, said back-off time is at least one said time slot.

15. The method for reducing loads of a mobility management entity in core networks according to claim 13, wherein said back-off time is set to be one said time slot initially, and wherein said back-off time is increased by adding two said time slots thereto each time until said back-off time exceeds a threshold time interval, whereafter said back-off time is reset to be one said time slot.

16. The method for reducing loads of a mobility management entity in core networks according to claim 13, wherein said back-off time is set to be one said time slot initially, and wherein said back-off time is increased according to a Fibonacci sequence each until said back-off time exceeds a threshold time interval, whereafter said back-off time is reset to be one said time slot.

17. The method for reducing loads of a mobility management entity in core networks according to claim 13, wherein said mobility management entity selects a time point within a preset grant time interval (GTI) randomly and asks said object to send out a connection-request message again at said time point, and wherein if said object still cannot interconnect with said core network, said mobility management entity selects a new time point behind said time point within said grant time interval, and a interval between that two time points is said back-off of said object.

18. The method for reducing loads of a mobility management entity in core networks according to claim 13, wherein said mobility management entity determines priorities of objects according to counts of rejections of said objects, and assigns said time point to an object having a highest count of rejections.
